(19) United States
(12) Patent Application Publication
(10) Pub. No.: US 2015/0324797 A1
(43) Pub. Date: Nov. 12, 2015

(54) PHONE-NUMBER-BASED PAYMENTS

(71) Applicant: TollShare, Inc., Danville, CA (US)

(72) Inventors: Murali M. Karamchedu, Portland, OR (US); Ravi Asnani, Los Angeles, CA (US)

(73) Assignee: TollShare, Inc., Danville, CA (US)

(21) Appl. No.: 14/274,651

(22) Filed: May 9, 2014

(51) Int. Cl. G06Q 20/40; G06Q 20/32; G06Q 20/30

(52) U.S. Cl. CPC G06Q 20/40; G06Q 20/30; G06Q 20/3255

(57) ABSTRACT

Methods, apparatuses, and computer-readable media directed to phone-number-based payments are described. A phone-number-based payment system (PBP) may be configured to facilitate payments between parties based on a phone number for a payer party. The PBP may be configured to receive a payment request for a payment to be made from the payer party to a payee party. The request may include a payment amount and the payer's phone number. The payment request may include a payment amount and a phone number for the customer. In response the payment request, the PBP may verify that the payee has an account with the PBP. The PBP may also request an authorization of the payment from the payer. After receiving authorization for the payment, the PBP may facilitate the requested payment from the payer to the payee. Other embodiments may be described and claimed.

### TECHNICAL FIELD

The present disclosure relates to the field of data processing, in particular, to apparatuses, methods and storage media associated with facilitating payments using phone numbers of payers.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Parties engage in financial transactions, and in particular transactions involving payment, every day. However, it is sometimes difficult for paid parties to easily perform non-cash payments. This is particularly true in cases where payees (such as vendors of goods and/or services) do not have resources easily at hand for taking such non-cash payments. For example, a vendor that sells goods only occasionally, such as at a farmer's market or flea market, may not have a payment system available that can take non-cash payments, such as credit or debit cards. Additionally, payers may elect not to use physical cards for non-cash payments, and may instead wish for the ability to conduct payments without sharing either physical cards or sensitive information, such as credit card numbers. This can cause difficulty for payers to use non-cash payment methods, and can frustrate potential customers of vendors.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for phone-number-based payment facilitation, in accordance with various embodiments.

FIG. 2 illustrates an example process for phone-number-based payment facilitation, in accordance with various embodiments.

FIG. 3 illustrates an example process for setting up phone-number-based payment facilitation, in accordance with various embodiments.

FIG. 4 illustrates an example process for receiving a payment request, in accordance with various embodiments.

FIG. 5 illustrates an example process for confirming a payment, in accordance with various embodiments.

FIG. 6 illustrates an example process for a client device to facilitate phone-number-based payments, in accordance with various embodiments.

FIG. 7 illustrates an example computing environment suitable for practicing various aspects of the present disclosure, in accordance with various embodiments.

FIG. 8 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. The term “messaging” as used herein may include instant messaging, personal messaging, text messaging, email, and so forth. Text messages may include messages sent using, e.g., short messaging service (SMS), or messages containing image, video, and sound content, e.g., multi-media messaging service (MMS).

In various embodiments, methods, systems, apparatuses, devices, and computer-readable media directed to phone-number-based payments are described. In various embodiments, a phone-number-based payment system (PBP) may be configured to facilitate payments between parties based on a phone number for a payer party (the party making payment). That is, under the PBP of the present disclosure, the phone number, in addition to its original intended usage as a communication address, also doubles as the primary means for tendering payment, superseding the prior art credit, debit or checking account numbers. The PBP may be configured to receive a payment request for a payment to be made from the payer party to a payee party (the party receiving payment). In embodiments, the request may be sent from the payee party and may include a payment amount and the payer's phone number (or information that enables the payer's phone number to be determined). The request may also include additional identifying information of the first party. For example, a payee vendor may send a request to the PBP to request payment from a payer customer. The payment request may include a payment amount and a phone number for the customer. The payment request may further include other identifying information for the payer. In another example, the payer may send a request, to the PBP to initiate a payment to a payee. The payment request may include the payer's phone number, if it has not been otherwise previously provided to, and determinable by, the PBP. In various embodiments, the payment request may be sent via various means, including text-based messaging and/or requests made with dedicated payment applications.

In embodiments, in response to receipt of the payment request, the PBP may verify that the payee has an account with the PBP. If the payment request is from the payee, the PBP may also request an authorization of the payment from the payer. In various embodiments, the request for authorization may be performed via a messaging protocol, or may be performed via a dedicated payment application. In various embodiment, the payer may provide one or more authentication secrets to the PBP, such as a password, in order to authorize the requested payment or request a payment. In various embodiments, after receiving authorization for the payment (and authenticating the authorization), the PBP may facilitate the requested payment from the payer to the payee. In various embodiments, funds for the payment may be taken from various accounts of the payer, such as checking accounts, debit accounts, and/or credit accounts. In various embodiments, payment may be made to the payee, such as to an account of the second party. In some embodiments, payment may be made through a payment facilitator, such as a wire payment service, which may be facilitated in generating a check or other wire payment to the payee. In some embodiments, the PBP itself may maintain accounts for the payer, and may make payment to the payee itself, without utilizing third-party payment entities; in such embodiments, the phone number of the payer may act as the primary (or sole) account number for the account held by the PBP.

In various embodiments, the phone-number-based payment techniques described herein may provide for easier conducting of payment between parties. For example, by providing facility for requesting a payment using a near-universally recognizable identifier, such as a phone number, the payer may be facilitated in making payments in a manner that is easier, and which may require less equipment, than by using more traditional credit card processing systems, which often requires the vendor to have elaborate credit card processing equipment, and pre-arrangement with credit card companies. Additionally, by allowing the use of a phone number to tender payments over commonly-used communication media, such as text messaging or mobile applications, the PBP may facilitate payment by not requiring special applications, hardware, or other equipment or resources than are commonly available to everyday payers and payees. Other benefits of the techniques described herein may be described below.

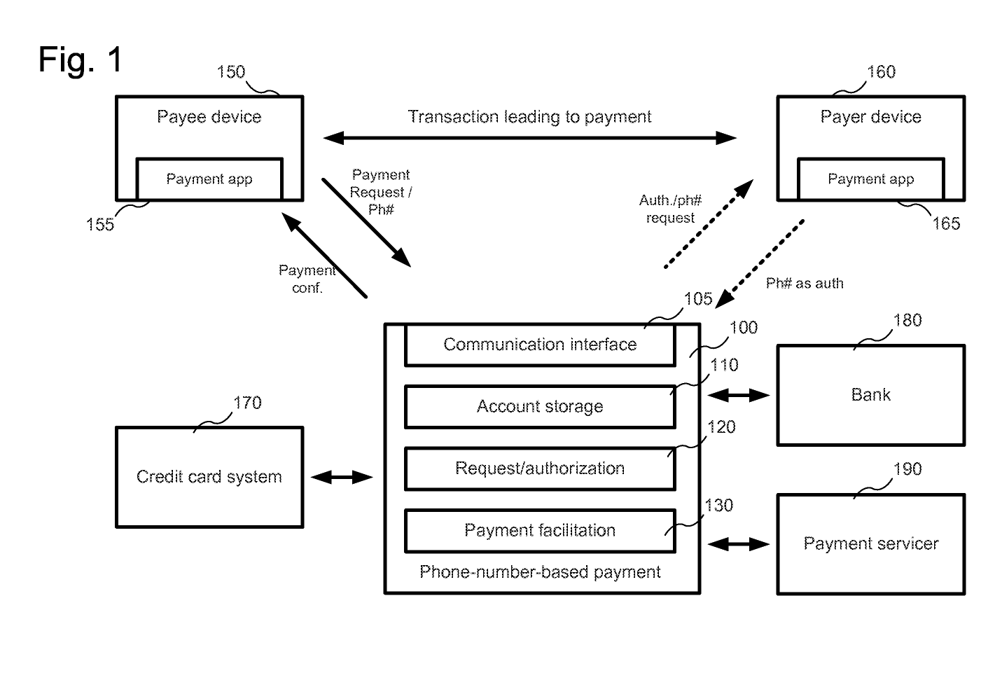

Referring now to FIG. 1, an example arrangement for phone-number-based payment facilitation may be illustrated in accordance with various embodiments. In various embodiments, while examples of particular activities may be described, no particular requirements may be made on the type of activity being performed by parties utilizing the PBP to facilitate phone-number-based payments. It may also be noted that, while particular entities and information flows are illustrated in FIG. 1, in various embodiments, entities and modules may be omitted, split into further entities or modules, or combined, and that other information may be sent between entities.

In various embodiments, a phone-number-based payment system 100 (PBP 100) may be configured to communicate with a payee device 150 and/or a payer device 160 to facilitate payment between a respective payee and payer associated with the devices. The payee device 150, payer device 160, and/or PBP 100 may include one or more computing devices and/or computing systems, including desktop computers, laptop computers, mobile phones, tablet computers, and/or other mobile or non-mobile devices. In various embodiments, the payee device 150 may include various devices configured to facilitate transactions, such as, for example, point-of-sale devices, cash registers, etc. In other examples, the payee device may include a device configured to also facilitate traditional payment via a credit or debit card, such as a dedicated card reader, or a mobile device executing a credit/debit card payment application. Such devices may be used, in various embodiments, even the PBP 100 facilitates payments through the use of telephone numbers, without requiring use of a credit or debit card. In various embodiments, such a device may nonetheless be equipped with a card reader to provide the payee the ability to accept a credit/debit card to for payment in the traditional manner. In other words, PBP 100 may co-exist with current payment methods. In embodiments, the traditional methods may handle the larger payments requiring higher level of security, while PBP 100 may handle the smaller payments requiring lower level of security, but higher ease-of-use. In various embodiments, payment may be requested in following a transaction that has been performed between the payee and the payer. While this is illustrated, for the sake of convenience in the FIG. 1 as interaction between the payee device 150 and the payer device 160, in various embodiments, it may be recognized that the actual transaction may be performed with or without the use of the one or more of the payee device 150 and the payer device 160.

In various embodiments, the payment request, as well as other communication associated with the techniques described herein, may be sent and received by respective payment application 155 (on the payee device 150) and payment application 165 (on the payer device 160) and/or a communication interface 105 of the PBP 100. In other embodiments, other applications or services, such as text messaging services, may be used to perform communication between the payee device 150, payer device 160, and the PBP 100; in some such embodiments, a messaging carrier (not illustrated) may be configured to communicate with payee device 150, payer device 160, and the PBP 100 to mediate messages. For example, in various embodiments, one or more communications may be performed via a text messaging protocol, such as a short message service (SMS) or multimedia messaging service (MMS); in such embodiments, the communication interface 105 may be configured to facilitate communication via these protocols. In such embodiments, the messaging carrier may include a wireless telephony carrier and the communication address may be a phone number for the payee, payer, or PBP 100. In other embodiments, the payment application 155, and/or payment application 165 may be configured to mediate messages sent over a different protocol, such as iMessage™, or via a non-messaging protocol; the communication interface 105 may similarly be configured to facilitate communication over these communication protocols.

In various embodiments, the PBP 100 may be configured to receive a payment request from the payment application 155 of the payee device 150. In various embodiments, the payment request may include a payment amount, as well as a phone number of the payer (or information enabling the phone number of the payer to be determined). The payment request, as described earlier, may also include identifying information for the payer. In other embodiments, the request may also include identifying information of the payee, such as, for example the payee's name, email address, physical address, etc (especially, if this information is not known to PBP 100.

In various embodiments, the PBP 100 may be configured, in response to receipt of the payment request from the payee, to request authorization of the payment from the payer. This authorization request may, in various embodiments, be sent to the payment application 165 of the payer device 160. In embodiments, PBP 100 may also authenticate the person giving the authorization, such as by requesting a password or a PIN. On authenticating the person providing the authentication, the PBP 100 may be configured to then send confirmation of the payment to the payee, such as at the payment application 155 of the payee device 150. Likewise, in embodiments, PBP 100 may also authenticate a payer requesting payment to a payee.

In various embodiments, the PBP 100 may be configured, in response to receive of the payment request and an authenticated payment authorization, to facilitate issuance of payment from the payer to the payee. In various embodiments, the PBP 100 may include an account storage 110 (AS 110), which may be configured to store information about various persons, including, but not limited to, payees who may be paid and/or payers who may pay. In various embodiments, the AS 110 may be located internally or externally to the PBP 100, and may include various techniques and implementations, as may be understood. In various embodiments, the AS 110 may include information about a payee, such as communication address/phone number information for the payee device 150 (such as to identify a payee when receiving a payment request), debit or credit account information, payment service information, etc. In various embodiments, the AS 110 may also include information about a payer, such as a phone number associated with the payer through which the payer may use to tender a payment, and secrets which the payer may use to be authorize a payment or authenticate its payment request. The AS 110 may also include communication address information for the payer device 160 (such as to identify a payer from a payment request), debit or credit account information, etc.

In other embodiments, the AS 110 may include information for a payment account held by the PBP 100 itself (or an entity associated with the PBP 100, such as a bank 180). For example, the payer may create an account, such as a credit or checking account, with a bank 180 associated with the PBP 100. The PBP 100 may thereafter utilize the phone number of the payer as the primary (or even sole) account number for the created account. Such usage may facilitate a bank in providing payment options to a payer without requiring the creation or sharing of additional account information, such as credit, debit, or checking account numbers.

In various embodiments, the PBP 100 may include one or more modules for performing techniques described herein. in various embodiments, the PBP 100 may include a request/authorization module 120 (RA 120), which may be configured to respond to receipt of a payment request from the payment application 155 of the payee device 150 to initiate a payment process, as well as to report back to the payee with a payment confirmation when the payment is complete. The RA 120 may also be configured, in various embodiments, to request authorization of a payment from a payer (including authentication), such as through requesting authorization from the payer via the payment application 165 of the payer device 160 and to receive authorization and authentication in response. Techniques for conducting payment request receipt and authorization (including authentication) may be described below.

In various embodiments, the PBP 100 may include a payment facilitation module 130 (“PF 130”). In various embodiments, the PF 130 may be configured to interact with one or more payment entities, such as a credit card system 170, a bank 180, or other payment servicer 190, to cause funds to be transferred between accounts associated with the payer and the payee. In various embodiments, the PF 130 may be configured to request debit and/or credit of one or more accounts, such as debit accounts, credit accounts, checking accounts, savings accounts, etc., which may be controlled by one or more of the credit card system 170 and/or bank 180. In other embodiments, the PF 130 may be configured to perform debit and or credit itself, in particular if the account being debited or credited is held by the AS 110 of the PBP 100. Particular techniques for facilitating payment may be described below.

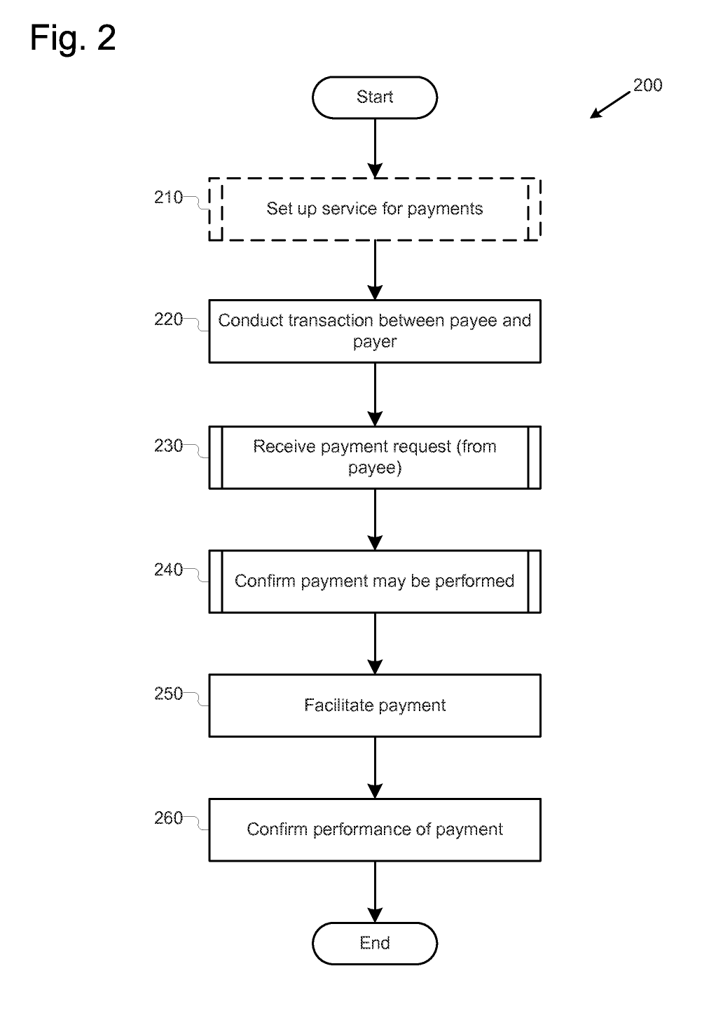

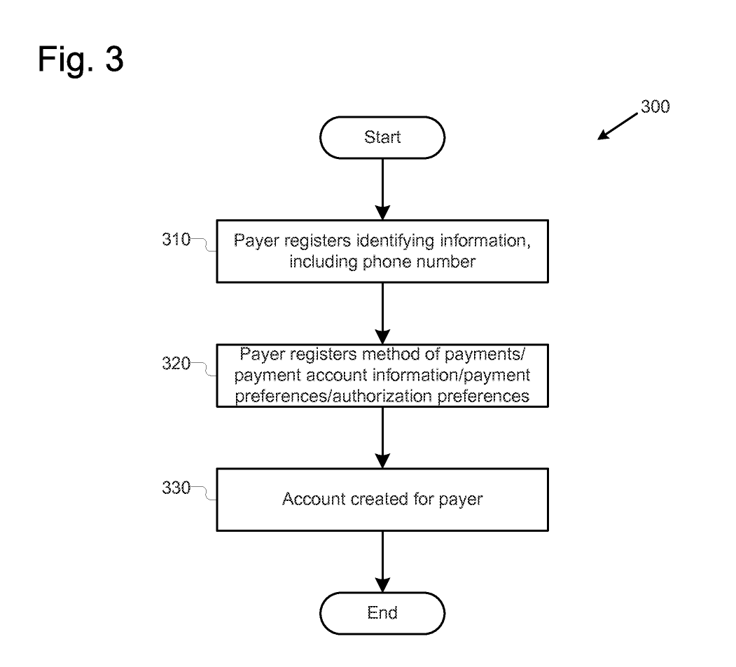

Referring now to FIG. 2, an example process for phone-number-based payment facilitation is illustrated in accordance with various embodiments. While FIG. 2 illustrates particular operations in a particular order, in various embodiments, the operations may be combined, split into parts, and/or omitted. The process may begin at operation 210, where the payee and/or payer may, in association with the AS 110, set up service to receive and/or make payments, respectively. In various embodiments, operation 210 may not be performed for every payment is made, but instead may be performed prior to issuance of payments. Particular examples of operation 210 may be described below with reference to process 300 of FIG. 3. Next, at operation 220, the payee and payer may conduct a transaction. In various embodiments, various types of transactions may be performed without restriction on the techniques described herein. For example, transactions may include a purchase of goods, a contract for services, a gift from one party to another, etc.

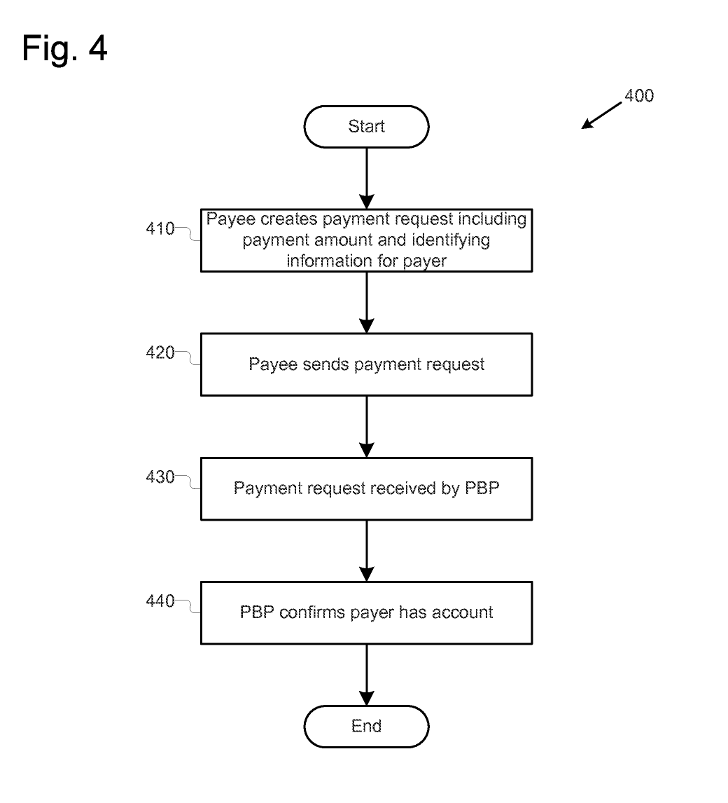

Next, at operation 230, the RA 120 may receive a payment request. For example, the payee, such as a vendor, may send a text message to the PBP 100 using the payment application 155 of the payee device 150, which may be received and processed by the RA 120. In another example, a payer may send a text message to the PBP 100 using the payment application 165 of the payer device 160, which may be received and processed by the RA 120. Particular examples of operation 230 may be described below with reference to process 400 of FIG. 4.

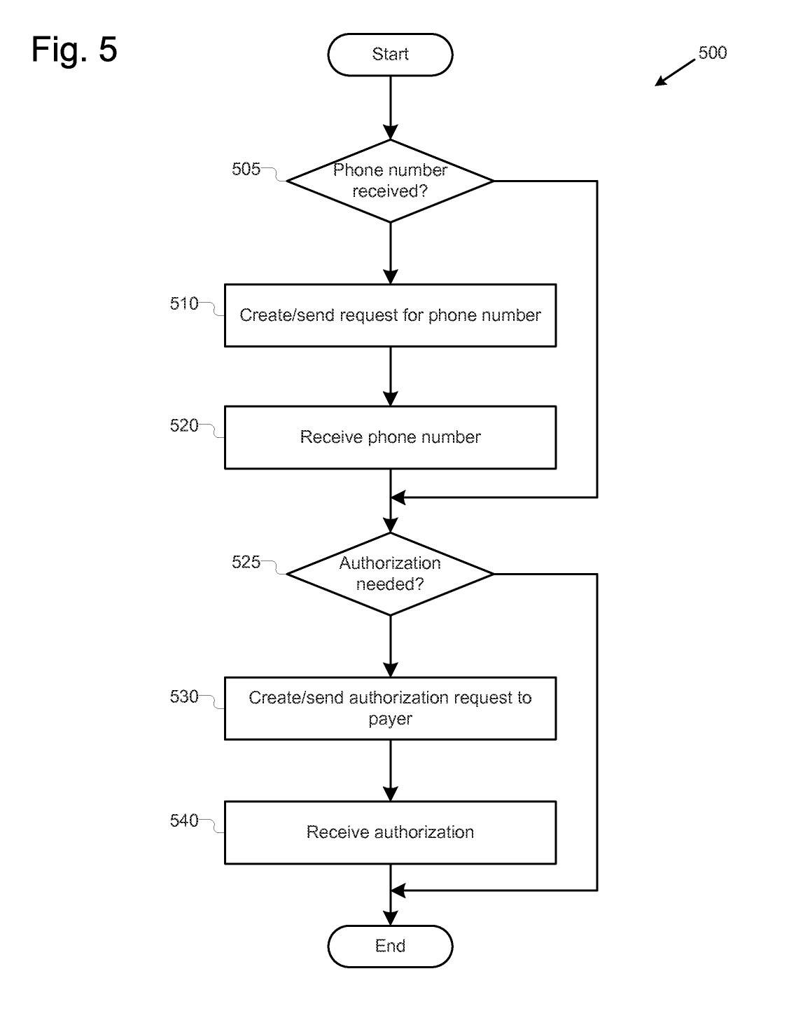

Next, at operation 240, the RA 120 of the PBP 100 may request confirmation of payment. The request may include authentication of the payer giving the authorization. For example, the RA 120 may send an authorization request to the payment application 165 of the payer device 160. Particular examples of operation 240 may be described below with reference to process 500 of FIG. 5.

Next, at operation 250, the PF 130 may facilitate the authenticated authorized payment. For example, the PF 130 may confirm the existence of funds in an account of the payer and/or may cause a debit and credit of funds between accounts of the payer and payee. In some embodiments, the payment may be made by requesting debit and credit from accounts maintained separately from the PBP 100. In other embodiments, such as when the PBP 100 itself maintains accounts for the payer, the PBP 100 may perform debit and/or credit of accounts it holds internally. Various methods of facilitating or performing payments may be understood by those of skill in the art. Next, at operation 260, the PF 130 (or other module of the PBP 100) may confirm the performance of the payment with the payer and/or the payee. Process 200 may then end.

Referring now to FIG. 3, an example process 300 for setting up phone-number-based payment facilitation is illustrated in accordance with various embodiments. While FIG. 3 illustrates particular operations in a particular order, in various embodiments, the operations may be combined, split into parts, and/or omitted. In various embodiments, the operations described in process 300 may be performed as one or more implementations of operation 210 of process 200. The process may begin at operation 310, where the payer may register identifying information with the AS 110. In various embodiments, the identifying information may include a phone number associated with the payer, and secrets for authentication. In various embodiments, the phone number may be a mobile phone number or a landline phone number (such as a work or home phone number). In various embodiments, the payer may also register other identifying information, such as name information, address information, IP addresses, email addresses, etc., that facilitate the PBP 100 in recognizing the identity of the payer when he or she makes a payment request.

Next, at operation 320, the payer may register payment information and/or preferences with the PBP 100. For example, the payer may register payment information such as such as credit/debit card account number, checking account number, etc. In other embodiments, at operation 320, the payer may register payment preferences. For example, the payer may register a payment threshold over which an authorization request may be required for payment—below this threshold the PBP 100 may facilitate payments based solely or primarily on receipt of a phone number associated with the payer without requiring additional authorization. In other embodiments, the payer may register a preference that a payment above (or below) a predetermined amount should be made from a particular account. In other embodiments, rather than register account information, the payer may request an account from the PBP 100, such as when the PBP 100 acts as (or is associated with) a bank 180. In such embodiments, the account created may be registered with the PBP 100 and referred to by the payer using the payer's (previously registered) phone number. In various embodiments, this phone number may act as the primary account number for the account with relation to payment performance using the account. After registration of identifying information, payment information and preferences, at operation 330, the AS 110 may create an account for the payer (or update an account if the account had previously been created). The process may then end.

It may be noted that, in the example of FIG. 3, operations are described with reference to the payer; in other embodiments, the payee may be facilitated by the AS 110 of the PBP 100 in performing similar operations, such as registering identifying information for the payee (such as phone numbers or other communication addresses) and or registration of payment information/preferences. In addition, in various embodiments, the payee may be facilitated by the AS 110 in registering account information, such as a mailing address, or saving or checking account information for receiving payment. This information may be stored and later used during facilitation of payments to the payee. In other embodiments, this information may not be stored, but may instead be provided by the payee as part of a payment request. It should be noted a party may be a payee in one transaction, and a payer in another transaction.

Referring now to FIG. 4, an example process 400 for receiving a payment request is illustrated in accordance with various embodiments. For ease of understanding, FIG. 4 will be described in the context of a payee vendor requesting payment, as noted earlier, in embodiments, the payment request may be made by the payer customer instead. While FIG. 4 illustrates particular operations in a particular order, in various embodiments, the operations may be combined, split into parts, and/or omitted. In various embodiments, the operations described in process 400 may be performed as one or more implementations of operation 230 of process 200. The process may begin at operation 410, where the payee may create a payment request. In various embodiments, the payment request may be created using the payment application 155 of the payee device 150. In various embodiments, the payment request may include a payment amount for the requested payment. In various embodiments, the payment request message may also include a phone number associated with the payer.

In various embodiments, the payment request may also include other identifying information for the payer, such as address information, name information, or information identifying communication addresses for the payer. In addition to the payment amount and identifying information, in some embodiments (e.g., the payee has not registered with PBP 100 or wishes to override some of the registered information), the payee may include in the payment request additional data that facilitates issuance of the payment. For example, in some embodiments, the payee may include an indication of a preferred method of payment and/or an account at which the payee wishes to receive payment. In other embodiments, the payee may include a password, or other proof of identity, in order to avoid fraudulent payments being made to the payee's account. In yet other embodiments, the payment request may not include identifying information and may only include a payment amount. In such embodiments, a second request may be sent for a phone number associated with the payer, along with other identifying information as well.

Next, after the payee creates the payment request, the payee may send the created payment request message to the PBP 100. In various embodiments, the payment request may be sent via messaging protocol, such as in a text message to be sent via SMS or MMS; such a message may include only text, or may include additional audio, video, and or images. In other embodiments, the payment request may not take the form of a message, but may be sent via other means using the payment application 155, such as, for example using an API or other interface supported by the PBP 100 through which payment requests may be made. Next, at operation 430, the payment request message may be received by the PBP 100.

After receiving the payment request message, at operation 440, the PBP 100, and in particular the RA 120, may confirm that the payer has an account registered with the AS 110 of the PBP 100. In various embodiments, at operation 450, the RA 120 may confirm that the payer has an account based on the phone number of the payer and other identifying information received in the payment request message. For example, the RA 120 may further determine whether there is indeed an account associated with the phone number based on the other identifying information, such as name, address, communication address. The RA 120 may utilize this identifying information to definitively confirm that the payer has an account registered with the PBP 100. In yet other embodiments, if no identifying information is provided during the initial payment request, the RA may be configured to confirm that the payer has an account at a later time, such as during an authorization action, described below. After operation 440, the process may end.

As discussed above, in alternative embodiments, the payment request may be created by the payer and sent from the payer device 160. In such embodiments, the payment request may include authentication information confirming that the payment request is indeed coming from the registered payer. Other embodiments described herein may operate in similar manners to those described herein while operating based on the payer-generated payment request.

Referring now to FIG. 5, an example process 500 for confirming that a payment may be performed is illustrated in accordance with various embodiments. As noted earlier, process 500 may be performed when the payment request is received from the payee. While FIG. 5 illustrates particular operations in a particular order, in various embodiments, the operations may be combined, split into parts, and/or omitted. In various embodiments, the operations described in process 500 may be performed as one or more implementations of operation 240 of process 200. The process may begin at decision operation 505, where the RA 120 may determine whether a phone number associated with the payer was received in the payment request. If no phone number was received, then at operation 510, the RA 120 may create and send a request for a phone number associated with the payer. In some embodiments, this request may be sent to the payee, such as through a text message, an API call, or other communication with the payment application 155 of the payee device 150. In other embodiments, if identifying information was received that identifies the payer, the RA 120 may request that the payer or a third party to provide the phone number associated with the payer. In some embodiments, entry of the phone number by the payer, on authentication, may act as an authorization of the payment. At operation 520, the phone number may be received by the RA 120, such as in a reply message, or a reply from the payment application 155 or 165 (depending on to whom the request for the phone number was sent).

In either event, whether a phone number was originally provided in the payment request or not, the process may continue to decision operation 525, where the RA 120 may determine whether authorization for the payment is needed. In some embodiments, if the payer has previously indicated that authorization is needed only for payments over a certain amount or of a certain type, then the RA 120 may determine whether authorization is needed at decision operation 525 based on this information. In other embodiments, the RA 120 may require authorization for any payment, for no payment, or for any payment by particular payers or to particular payees. In yet other embodiments, if a phone number was requested at operation 510 and received from the payer at operation 520, on authentication, the RA 120 may consider the payment to be authorized and may not require further authorization at decision operation 525.

If no authorization is required, the process may end after decision operation 525. If, however, authorization is determined to be needed, then at operation 530, the RA 120 may create and send an authorization request to the payer, such as through a message, API call, or other communication with the payment application 165. At operation 540, the RA may receive an authorization. In various embodiments, the authorization received may include authentication data indicating that an authorization was performed by the payer, such as by replying with a particular word, password, PIN, or message, or by performing a signature using the payer device 160. The process may then end.

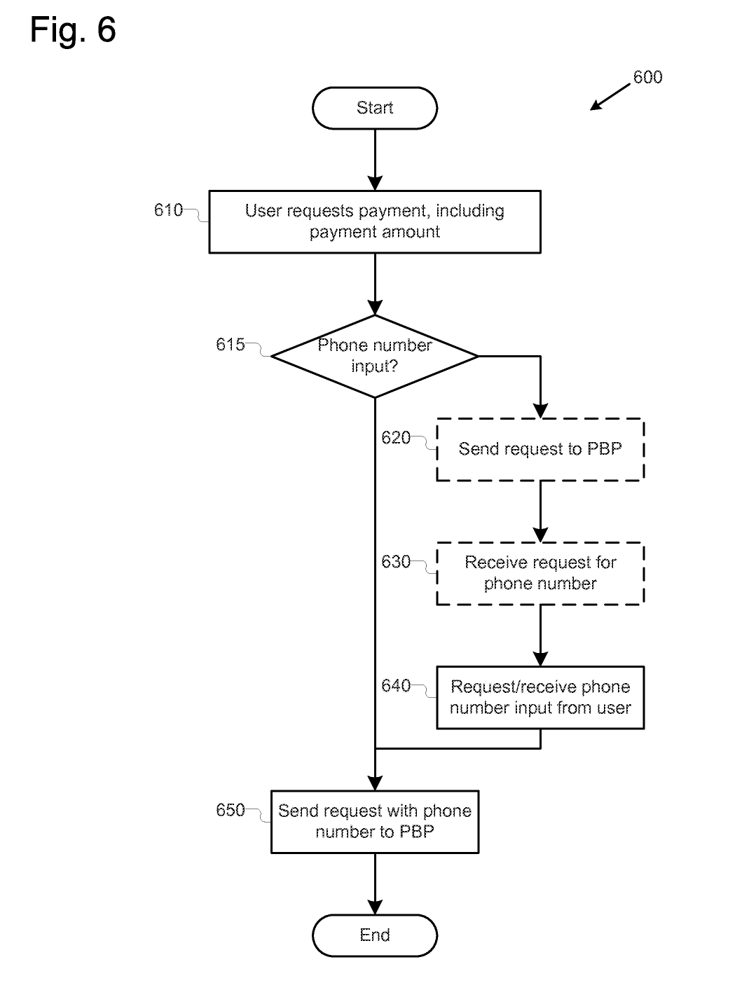

Referring now to FIG. 6, an example process 600 for a client device to facilitate phone-number-based payments is illustrated in accordance with various embodiments. While FIG. 6 illustrates particular operations in a particular order, in various embodiments, the operations may be combined, split into parts, and/or omitted. In various embodiments, the operations described in process 600 may be performed alongside the actions of processes 400 and 500 of FIGS. 4 and 5. In various embodiments, the process of FIG. 6 may be performed by either the payment application 155 of the payee device 150 or the payment application 165 of the payer device 160. The process may begin at operation 610, where a user, such as the payer or payee may be request a payment, including a payment amount, such as by sending a payment request as discussed above. Next, at decision operation 615, the process may include different operations depending on whether a phone number or information enabling determination of the phone number was input with the payment request. If the phone number was input, then at operation 650, the payment application 155 or 165 may send a payment request, including the phone number, to the PBP 100.

If, however, no phone number was input, then at operation 620, the payment application 155 or 165 may send a payment request to the PBP 100 that does not include a phone number associated with the payer. Next, at operation 630, the payment application 155 or 165 may receive a request from the PBP 100 for a phone number associated with the payer. After receiving the request, at operation 640, the payment application 155 or 165 may request and receive an input of a phone number associated with the payer from the payer or payee. In some embodiments, operations 620 and 630 may not be performed and instead the payment application 155 or 165 may automatically request the phone number from the payer or payee upon the payer or payee attempting to send a payment request. After receiving the phone number, at operation 650, the payment application 155 or 165 may send a payment request, including the phone number, to the PBP 100. The process may then end. In other words, the payment request made be made in one or multiple communication exchanges to provide the payment amount, the phone number of the payer, and optionally, other information.

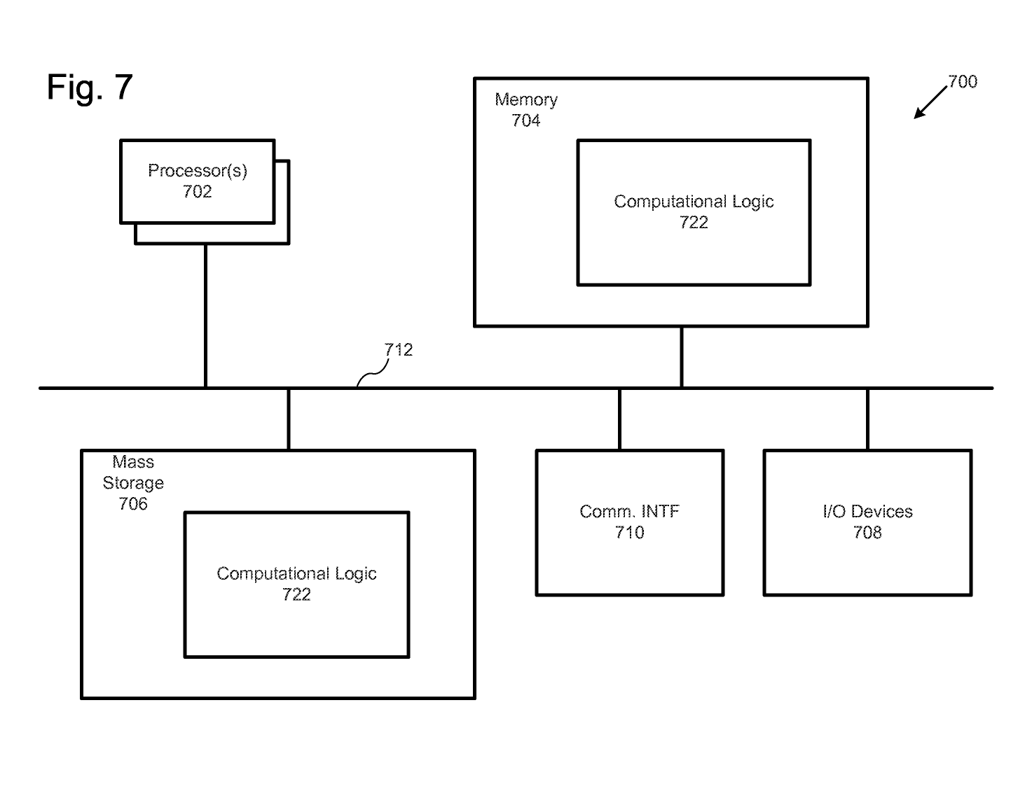

Referring now to FIG. 7, an example computer suitable for practicing various aspects of the present disclosure, including processes of FIGS. 2-6, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth), and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the modules shown in FIG. 1, and/or the operations associated with techniques shown in FIGS. 2-6, collectively referred to as computing logic 722. The various elements may be implemented by assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices. In embodiments, the programming instructions may be stored in one or more computer readable non-transitory storage media. In other embodiments, the programming instructions may be encoded in transitory storage media, such as signals.

The number, capability and/or capacity of these elements 710-712 may vary. Their constitutions are otherwise known, and accordingly will not be further described.

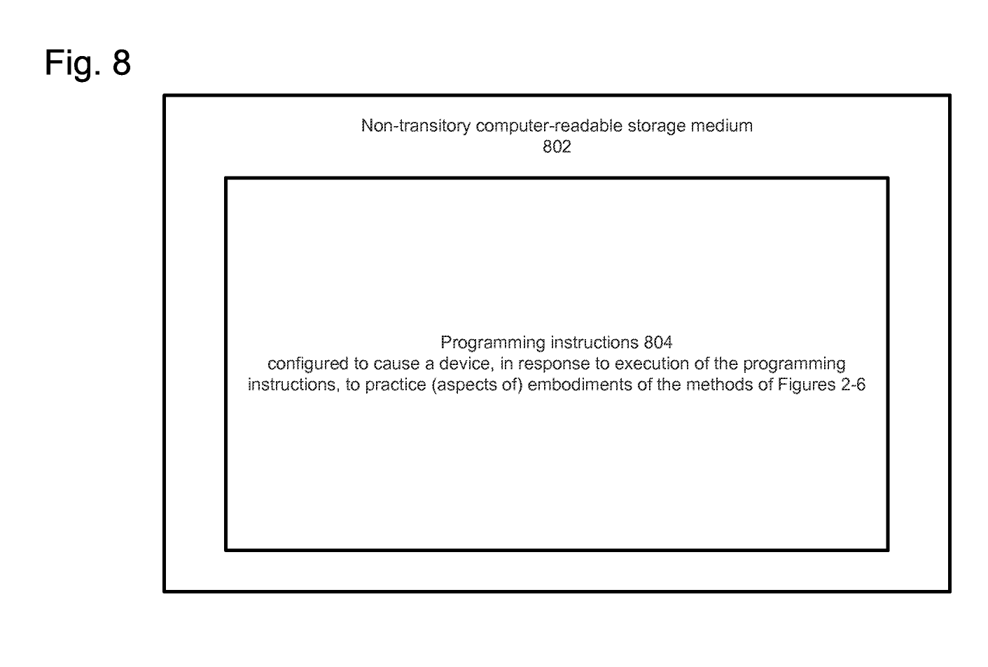

FIG. 8 illustrates an example least one computer-readable storage medium 802 having instructions configured to practice all or selected ones of the operations associated with the techniques earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 2-6, e.g., but not limited to, to the various operations performed to perform facilitation of phone-number-based payments. In alternate embodiments, programming instructions 804 may be disposed on multiple least one computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable media comprising instructions to cause a computing system, in response to execution by the computing system, to facilitate payments, wherein the computing system is caused to:
receive a payment request to facilitate a first party in making a payment to a second party, wherein the payment request identifies a payment amount;
receive a phone number associated with the first party; and
in response to receipt of the payment request and the phone number, facilitate payment from the first party to the second party of the payment amount from an account associated with the first party.

2. The one or more computer-readable media of claim 1, wherein receive a phone number associated with the first party comprises receive the phone number in the payment request.

3. The one or more computer-readable media of claim 1, wherein:
receive a payment request comprises receive identifying information for the first party other than the phone number associated with the first party; and
the computing system is further caused to confirm that the first party authorizes payment of the payment amount to the second party based at least in part on the received identifying information.

4. The one or more computer-readable media of claim 3, wherein confirm that the first party authorizes payment of the payment amount to the second party comprises confirm that the identifying information is registered as being associated with the phone number associated with the first party.

5. The one or more computer-readable media of claim 3, wherein confirm that the first party authorizes payment comprises:
send an authorization request message to the first party based in part on the identifying information for the first party; and
receive a reply message from the first party that authorizes the payment.

6. The one or more computer-readable media of claim 5, wherein:
send an authorization request message comprises send a request for the phone number associated with the first party; and
receive the reply message comprises receive a reply message including the phone number associated with the first party.

7. The one or more computer-readable media of claim 5, wherein:
the identifying information for the first party comprises a communication address for communication with the first party via a messaging protocol; and
send an authorization request message to the first party comprises send the authorization request message via the messaging protocol.

8. The one or more computer-readable media of claim 1, wherein receive a payment request comprises receive the payment request in the form of a text message via a text messaging protocol.

9. The one or more computer-readable media of claim 8, wherein receive the payment request in the form of a text message comprises receive the payment request in the form of a text message from the second party.

10. The one or more computer-readable media of claim 1, wherein the second party is a vendor.

11. The one or more computer-readable media of claim 8, wherein receive the payment request in the form of a text message, comprises receive the payment request in the form of a text message from the first party.

12. The one or more computer-readable media of claim 1, wherein facilitate payment from the first party to the second party comprises facilitate a bank transfer from an account of the first party to an account of the second party.

13. The one or more computer-readable media of claim 1, wherein facilitate payment from the first party to the second party comprises perform payment using an account held by the computing system.

14. One or more computer-readable media comprising instructions to cause a computing system, in response to execution by the computing system, to facilitate payments, wherein the computing system is caused to:
receive a payment request to facilitate a first party in making a payment to a second party, wherein the payment request identifies a payment amount;
request a phone number associated with the first party;
receive the phone number; and
in response to receipt of the payment request and the phone number, request that a payment service make a payment from the first party to the second party of the payment amount from an account associated with the first party.

15. The one or more computer-readable media of claim 13, wherein receive a payment request and receive a phone number comprise receive the payment request and the phone number from the first party.

16. The one or more computer-readable media of claim 13, wherein receive a payment request and receive a phone number comprise receive the payment request and phone number from the second party.

17. The one or more computer-readable media of claim 13, wherein the computing system is further caused to confirm with the first party that the payment is authorized by the first party.

18. The one or more computer-readable media of claim 13, wherein confirm with the first party that the payment is authorized by the first party comprises confirm, based on receipt of the phone number associated with the first party, that the first party authorizes payment.

19. The one or more computer-readable media of claim 13, wherein the computing system is caused to perform the receive a payment request, request a phone number, and receive the phone number though a payment application executing on the computing system.

20. An apparatus for facilitation of payments, the apparatus comprising:
one or more computer processors; and
logic to operate on the one or more computer processors to:
receive a payment request to facilitate a first party in making a payment to a second party, wherein the payment request identifies a payment amount;
receive a phone number associated with the first party; and
in response to receipt of the payment request and the phone number, facilitate payment from the first party to the second party of the payment amount from an account associated with the first party.

21. The apparatus of claim 21, wherein receive a phone number associated with the first party comprises receive the phone number in the payment request.

22. The apparatus of claim 21, wherein:
receive a payment request comprises receive identifying information for the first party other than the phone number associated with the first party; and
the logic is further to confirm that the first party authorizes payment of the payment amount to the second party based at least in part on the received identifying information.

23. The apparatus of claim 22, wherein confirm that the first party authorizes payment comprises:
send an authorization request message to the first party based in part on the identifying information for the first party; and
receive a reply message from the first party that authorizes the payment.

24. The apparatus of claim 23, wherein:
the identifying information for the first party comprises a communication address for communication with the first party via a messaging protocol; and
send an authorization request message to the first party comprises send the authorization request message via the messaging protocol.

25. The apparatus of claim 21, wherein receive a payment request comprises receive the payment request in the form of a text message via a text messaging protocol.

26. The apparatus of claim 21, wherein facilitate payment from the first party to the second party comprises facilitate a bank transfer from an account of the first party to an account of the second party.

27. An apparatus for facilitation of payments, the apparatus comprising:
one or more computer processors; and
logic to operate on the one or more computer processors to:
receive a payment request to facilitate a first party in making a payment to a second party, wherein the payment request identifies a payment amount;
request a phone number associated with the first party;
receive the phone number; and
in response to receipt of the payment request and the phone number, request that a payment service make a payment from the first party to the second party of the payment amount from an account associated with the first party.

28. The apparatus of claim 27, wherein receive a payment request and receive a phone number comprise receive the payment request and the phone number from the first party or the second party.

29. The apparatus of claim 27, wherein the logic is further to confirm with the first party that the payment is authorized by the first party.
